(19) United States
(12) Patent Application Publication
(10) Pub. No.: US 2005/0010434 A1
(43) Pub. Date: Jan. 13, 2005

(54) Vending machine management system and method of managing vending machines

(75) Inventors: Kuniko Sasajima, Tokyo (JP); Haruyasu Toda, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/885,722

(22) Filed: Jul. 8, 2004

(30) Foreign Application Priority Data
Jul. 9, 2003 (JP) 2003-272425

(51) Int. Cl. G06F 17/60

(52) U.S. Cl. 705/1

(57) ABSTRACT

A vending machine management system includes a network; a plurality of vending machines, which are connected with the network, and a maintenance terminal. Each of the plurality of vending machines transmits a trouble data indicative of a trouble to a selling of articles stocked in the trouble occurring vending machine. The maintenance terminal receives the trouble data from the vending machine, and displays an operation state data indicative of a state of the trouble occurring vending machine.

### BACKGROUND OF THE INVENTION

1. Field of the Invention

The present invention relates to a vending machine management system.

2. Description of the Related Art

A system for carrying out remote maintenance of a vending machine on a network is conventionally established. However, the above-mentioned conventional vending machine has the following problems. At first, a communication cost is expensive, and it is impossible to quickly access the vending machine when detailed information is desired. Therefore, it is impossible to manage the vending machines when the vending machines increase. Also, the articles to be stocked in the conventional vending machine must be prepared on the basis of past experience, and excess articles are transported to the vending machine. Also, the detection of a failure of the vending machine and the repair of the vending machine must be carried out at an installation place of the vending machine. It takes a long time for the repair, resulting in losing a chance of selling the articles.

Also, conventionally, a vending machine having a WWW server function is known in Japanese Laid Open Patent Application (JP-P2000-149104A: a first conventional example). However, in this conventional example, the cost of the vending machine rises.

In conjunction with the above description, a vending machine network system is disclosed in Japanese Laid Open Patent Application (JP-A-Heisei 11-185120). In this conventional example, a vending machine is loaded with a standard protocol of a computer network, and has a server function with a protocol for the Internet. Data of the vending machine can be viewed from a personal computer or a work station through a network.

Also, a vending machine managing system is disclosed in Japanese Laid Open Patent Application (JP-P2001-250153A). In this conventional example, the vending machine detects the state of each of sections provided in the vending machine and reports to a management center. The management center transmits an adjustment instruction of the vending machine to the vending machine based on the received state of each section.

Also, a maintenance system of a vending machine is disclosed in Japanese Laid Open Patent Application (JP-P2002-42218A) . In this conventional example, vending machines, a vending machine operator and a data center are connected by a network. Each of the vending machines has a failure detecting function and a communication function. A failure data is transmitted to the data center through the network, and then transmitted from the data center to the vending machine operator through the network.

Also, a vending machine is disclosed in Japanese Laid Open Patent Application (JP-P2003-58938A). In this conventional example, when receiving a failure notice, a mail destination data is retrieved as an initial setting data from a vending machine management apparatus to select a mail address of a serviceman. A location data is produced and a E-mail is produced by adding the location data to a notice which contains trouble occurrence date and time, a trouble content, and a trouble measurement, and is transmitted to the serviceman.

### SUMMARY OF THE INVENTION

An object of the present invention is to provide a vending machine management system in which vending machines can be managed well.

In an aspect of the present invention, a vending machine management system includes a network; a plurality of vending machines, which are connected with the network, and a maintenance terminal. Each of the plurality of vending machines transmits a trouble data indicative of a trouble to a selling of articles stocked in the trouble occurring vending machine. The maintenance terminal receives the trouble data from the vending machine, and displays an operation state data indicative of a state of the trouble occurring vending machine.

Here, the vending machine management system may further include a mobile terminal which is carried by a sales engineer and receives and displays the operation state data which is transmitted from the maintenance terminal. In this case, the maintenance terminal transmits a data transmission request to the trouble occurring vending machine in response to the reception of the trouble data, and the trouble occurring vending machine transmits the operation state data to the maintenance terminal.

Also, the mobile terminal issues an area data request to the maintenance terminal. The maintenance terminal searches a plurality of vending machine allocated to the sales engineer, and transmits the data transmission request to the plurality of searched vending machines other than the trouble occurring vending machine in response to the area data request. Each of the plurality of searched vending machines other than the trouble occurring vending machine transmits the operation state data to the maintenance terminal. The maintenance terminal produces an area data indicative of states of the plurality of searched vending machines from the received operation state data and transmits the area data to the mobile terminal, and the mobile terminal displays the area data.

Also, the maintenance terminal transmits a state data request to the plurality of vending machines periodically. Each of the plurality of vending machines transmits the operation state data to the maintenance terminal in response to the state data request, and the maintenance terminal holds the operation state data of each of the plurality of vending machines. In this case, the vending machine management system may further include a sales management system; and a selling system terminal collects the operation state data of each of the plurality of vending machines and drives the sales management system to carry out a sales analysis based on the collected operation state data.

Also, an IPv6 address may be allocated to each of the plurality of vending machines such that each of the plurality of vending machines is identified based on the IPv6 address on the Internet.

Also, each of the plurality of vending machines and the maintenance terminal may communicate with each other on the Internet by using VLAN.

In another aspect of the present invention, a method of managing vending machines, may be achieved by collecting an operation state data indicative of a state of each of vending machines from each of the vending machines by a maintenance terminal; by transmitting a trouble data indicative of a trouble to a selling of articles stocked in a trouble occurring vending machine of the vending machines from the trouble occurring vending machine to the maintenance terminal; by transmitting the operation state data of the trouble occurring vending machine from the maintenance terminal to a mobile terminal; and by displaying the operation state data of the trouble occurring vending machine on the mobile terminal.

The collecting may be carried out periodically. Also, the method may further include transmitting an operation state data request from the maintenance terminal to the trouble occurring vending machine; and transmitting the operation state data from to the trouble occurring vending machine to the maintenance terminal in response to the operation state data request.

In another aspect of the present invention, a software product executable by a computer, includes the functions of: accessing vending machines through a network to acquire an operation state data from each of the vending machines; and transmitting the operation state data of a trouble occurring vending machine of the vending machines to a mobile terminal carried by a sales engineer in response to a reception of a trouble data indicative of a trouble to a selling of stocked articles from the trouble occurring vending machine.

Here, the transmitting the operation state data may include the functions of: transmitting a data transmission request to the trouble occurring vending machine in response to the reception of the trouble data; receiving the operation state data from the trouble occurring vending machine transmits; and transmitting the received operation state data to the mobile terminal.

Also, the software product may further include the functions of: searching the vending machine allocated to the sales engineer in response to an area data request; transmitting a data transmission request to the searched vending machines other than the trouble occurring vending machine; receiving the operation state data each of the searched vending machines other than the trouble occurring vending machine; producing an area data indicative of states of the searched vending machines from the received operation state data; and transmitting the area data to the mobile terminal, such that the mobile terminal displays the area data.

Also, the accessing may include the function of: accessing the vending machines periodically through a network to acquire an operation state data from each of the vending machines.

Also, the software product may further include the functions of: collecting the operation state data of each of the vending machines; and. carrying out a sales analysis based on the collected operation state data.

### BRIEF DESCRIPTION OF THE DRAWINGS

FIG. 1 is a block diagram showing the configuration of a vending machine management system according to a first embodiment of the present invention;

FIG. 2 is a block diagram showing the configuration of a vending machine in a vending machine management system according to the first embodiment of the present invention;

FIG. 3 is a flowchart showing an operation of the vending machine management system according to the first embodiment of the present invention;

FIG. 4 is a diagram showing a screen display on a maintenance terminal according to the first embodiment of the present invention;

FIG. 5 is a diagram showing a screen display on a mobile terminal as a PDA;

FIGS. 6A and 6B is a diagram showing a screen display on a mobile terminal as a portable telephone;

FIG. 7 is a diagram showing another screen display on a mobile terminal as the PDA;

FIG. 8 is a block diagram showing the configuration of a vending machine management system according to a second embodiment of the present invention; and

FIG. 9 is a flowchart showing an operation of the vending machine management system according to a second embodiment of the present invention.

### DESCRIPTION OF THE PREFERRED EMBODIMENTS

Hereinafter, a vending machine management system of the present invention will be described in detail with reference to the attached drawings.

In the present invention, maintenance of a vending machines can be properly carried out and selling data can be used for the sales analysis, by using operation data obtained through two-way communication between the vending machine and control terminals such as a maintenance terminal, a selling system terminal, a sales management system and a mobile terminal on the network corresponding to IPv6.

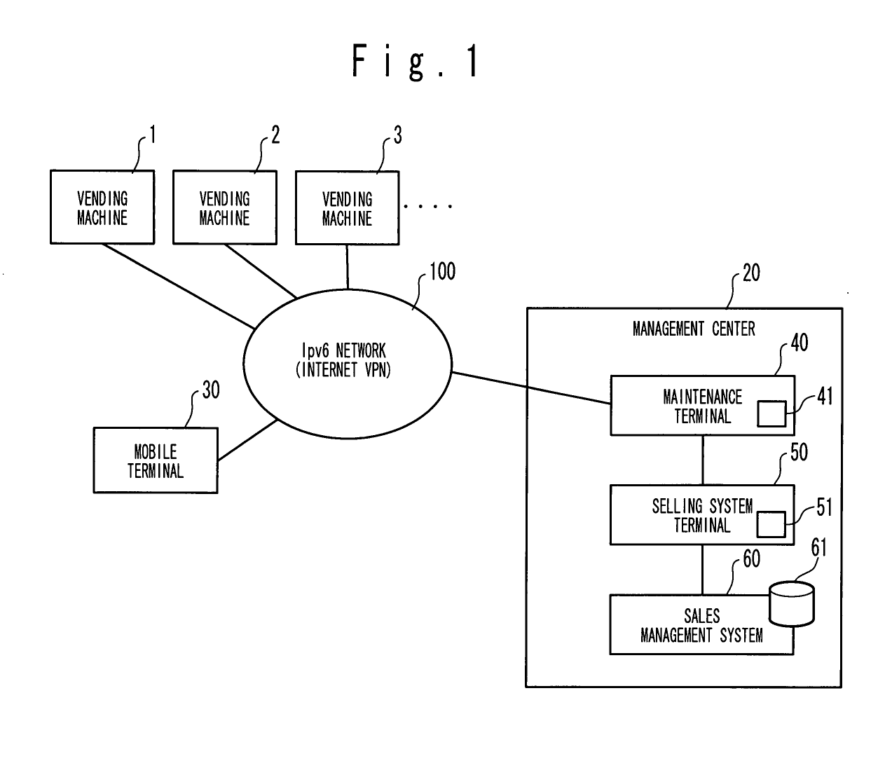

Referring to FIG. 1, the vending machine management system according to the first embodiment of the present invention is composed of vending machines 1, 2 and 3, a management center 20 and a mobile terminal 30. These are connected with each other through a network 100 such as the Internet, on which VPN is built up. The management center 20 is composed of a maintenance terminal 40 with a table 41, a selling system terminal 50 with an operation state data database 51, and a sales management system 50 with a storage unit 61.

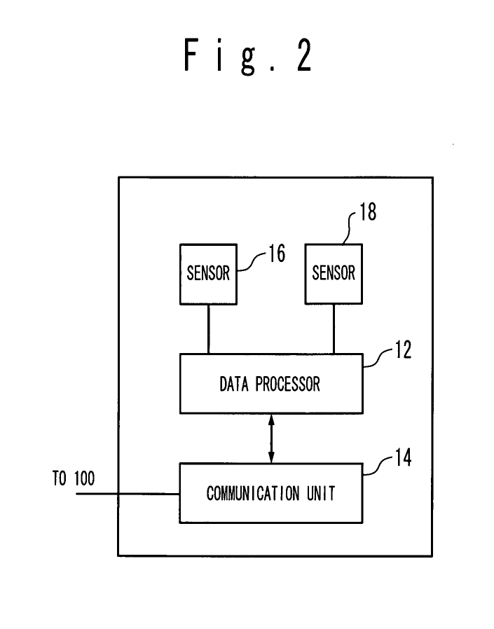

Referring to FIG. 2, each of the vending machines 1, 2 and 3 is composed of a data processor 12, a communication unit 14, a change sensor 16 and a stock sensor 18. The change sensor 16 detects the state of changes to generate a change data. The change data indicates an amount of changes for every kind of coins and bills. In case of lack of any change so that change cannot be paid for coins or a bill, change lack data is generated. The stock sensor 18 detects the stock state of the articles to be stocked in the vending machine to generate article stock data. The article stock data indicates the number of articles for every kind. In case of lack of articles stocked in the vending machine, an article stock lack data is generated. The vender machine further contains various sensors (not shown) in addition to the change sensor 16 and the stock sensor 18. For example, the vending machine contains a sensor for detecting a failure of the vending machine to generate a machine failure data. The vending machine may contain a sensor for monitoring a peripheral region to detect an extraordinary situation. The communication unit 14 has a communication function of IPv6 and can communicate with the maintenance terminal 40 of the management center 20 through the network 100. The data processor 12 is connected with the sensors and checks of the state of the vending machine. The data processor 12 generates a trouble data based on the machine failure data, the change lack data and the article stock lack data. The operation state data contains the change data and the article stock data in addition to the trouble data. The data processor 12 controls the communication unit 14 to transmit to the maintenance terminal 40, the trouble data on the operation of the vending machine when any of the sensors indicates an extraordinary state, or the operation state data indicative of the state of the vending machine in response to a data transmission request from the maintenance terminal 40. The data transmission request is transmitted from the maintenance terminal 40 periodically and at any time, if necessary. However, the vending machine may contain a timer and transmit the operation state data automatically and periodically.

The maintenance terminal 40 contains a table 41 which stores the operation state data for each of the vending machines 1 to 3. The operation state data contains a common data such as vending machine No., an installation place of the vending machine, a sales engineer or a group in charge of the vending machine, date and time and map data indicating the installation place. The trouble data contains a predetermined code No. to indicate a kind of trouble such as the lack of each article and the lack of changes. The trouble data further contains a situation indicated by the trouble data, a previous trouble situation and a date of the previous trouble occurrence, a trouble count, a temperature in the vending machine and an ambient temperature. The operation state data contains the change data and the article stock data in addition to the trouble data. The code No. and situation of the trouble data are empty when the operation state data is transmitted periodically.

Also, the maintenance terminal 40 receives the trouble data from any of the vending machines 1, 2, 3, transmits the data transmission request to the vending machine to receive the operation state data, and displays the operation state data on the Web browser. This can be attained by a program described to automatically re-load the operation state data gathered from the vending machine by the maintenance terminal 40 on a home page. the program is described in Perl or JAVA (registered trademark), and the home page is displayed on the Web browser. Also, this can be attained by displaying this home page on the Web browser by using a push technique for each event occurrence. The maintenance terminal 40 periodically accesses all the vending machines 1, 2, 3 and gathers and stores the operation state data in the table 41

The mobile terminal 30 is a data processing terminal carried by a sales engineer of the vending machine 1, and this may be PDA or a portable telephone that can be connected to the Internet. Also, the mobile terminal 30 receives the trouble data of the vending machine 1 from the maintenance terminal 40, and displays on the screen. Also, the mobile terminal 30 displays the operation state data of the vending machines allocated to the sales engineer.

An operations of the vending machine management system in the first embodiment will be described below in detail with reference to FIGS. 1 to 6.

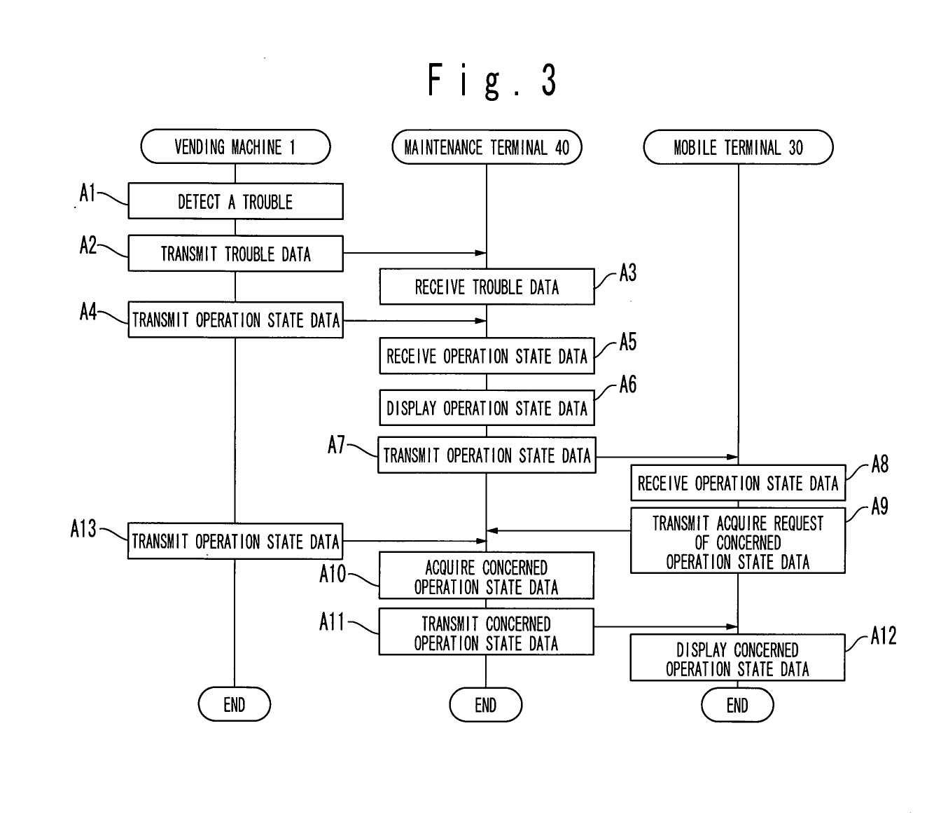

Referring to FIG. 3, when a sensor in any of the vending machines 1 to 3, e.g., the vending machine 1 detects occurrence of a trouble (Step A1), the data processor 12 of the vending machine 1 controls the communication unit 14 to transmit the trouble data to the maintenance terminal 40 of the managing center 60 through the Internet 100 (Step A2). For the transmission, a predetermined protocol such as HTTP and TELNET on TCP/IP is used but a unique protocol may be used. The maintenance terminal 40 receives the trouble data (Step A3), and transmits a data transmission request to the vending machine 1 based on an IPv6 address of the vending machine 1 as a transmission source. The vending machine 1 transmits the operation state data containing the article stock data and the change data to the maintenance terminal 40 (Step A4).

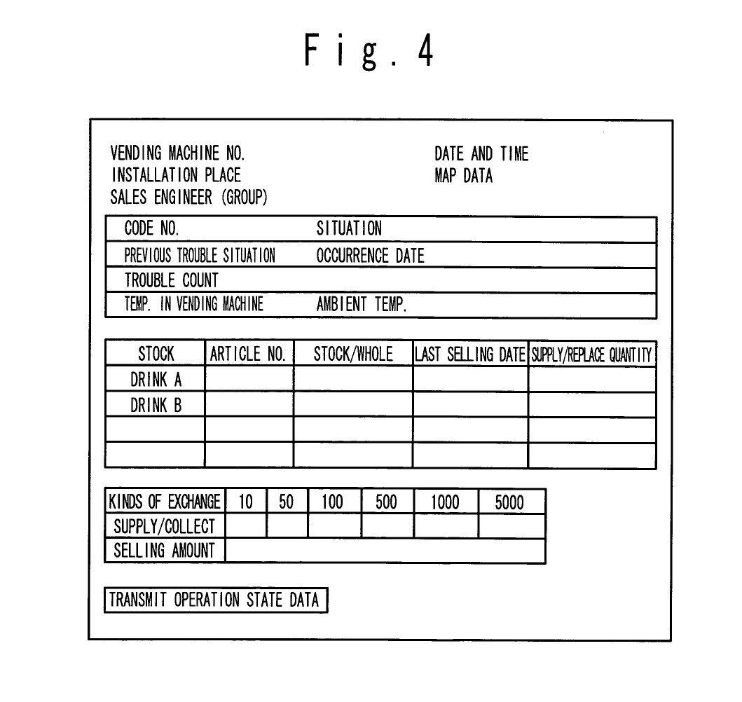

The maintenance terminal 40 receives the operation state data of the vending machine 1 at the present time (Step A5), and merges the trouble data into the operation state data and stored it in the table 41. Then, the maintenance terminal 40 displays the operation state data of the vending machine 1 together with the trouble data on the home page (Step A6). The data shown in FIG. 4 is displayed on the maintenance terminal 40. The display data contains a vending machine number, an installation place, a sales engineer and its group, a date and time, a map data (address and the like), a code number of a trouble, a situation in a trouble, a situation at a previous trouble occurrence, a date of the trouble occurrence in this case, the number of troubles, a temperature inside the vending machine and a temperature outside the vending machine. The display data further contains an article name, an article number, the number of stocks, a stock possible number, a last selling date and a supply/replace quantity for each slot, and a supply/collect quantity for each coin kind are displayed on an image screen. Here, the supply/replace amount for each slot is the last supply quantity/last replace quantity. For example, when 30 articles are last supplied, it is represented as [30/0], and when 40 articles are last replaced, it is represented as [0/40]. Also, the supply/collect quantity for each coin kind is the quantity of the last supplied coins/the quantity of the last collected coins. For example, when 100 coins are last supplied, it is represented as [100/0], and when 55 coins are last collected, it is represented as [0/55]. An operator of the managing center 20 can click a button [Transmit Article stock data] under the screen and transmit as the newest data to the table 41.

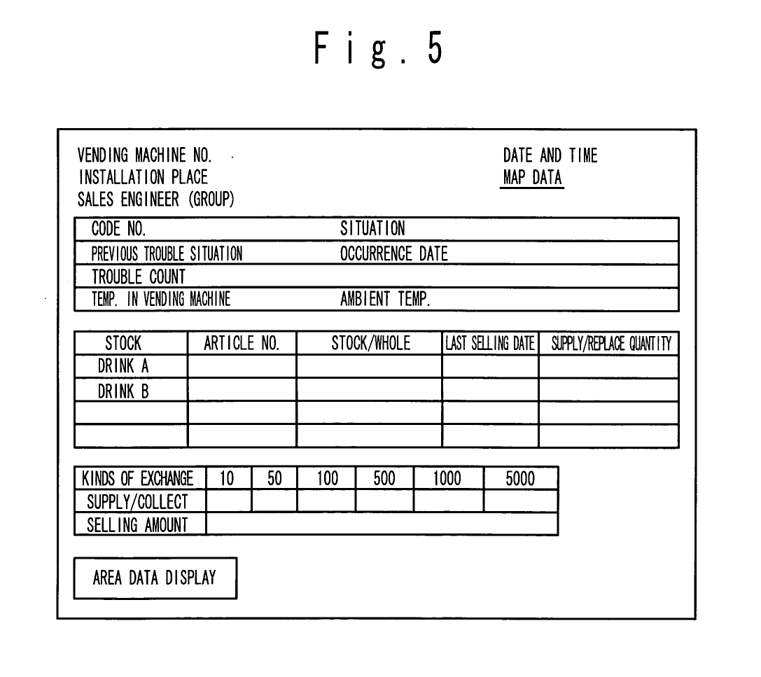

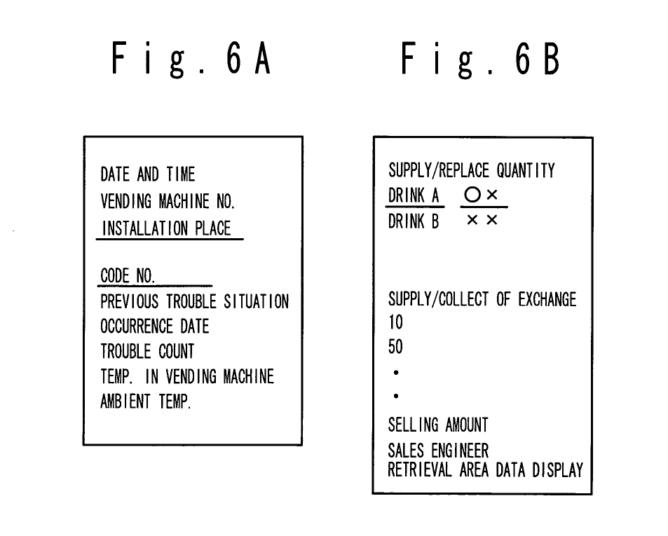

Next, the maintenance terminal 40 shown in FIG. 3 transmits the operation state data displayed at the step A6 to the mobile terminal 30 through the Internet VPN 100 in response to the reception of the trouble data (Step A7). The mobile terminal 30 carried by the sales engineer in charge of the vending machine 1 receives the operation state data of the vending machine 1 (Step A8). The mobile terminal 30 displays the received operation state data on a display screen as shown in FIG. 5. The display is similar to the screen shown in FIG. 4 and displayed on the maintenance terminal 40. When the screen size of the mobile terminal 30 is small, the displays as shown in FIGS. 6A and 6B are carried out depending on the kind of the mobile terminal 30. After checking the situation of the vending machine 1, the sales engineer pushes an “all area data display” button to acquire the operation state data of all of the vending machines to which the sales engineer is in charge.

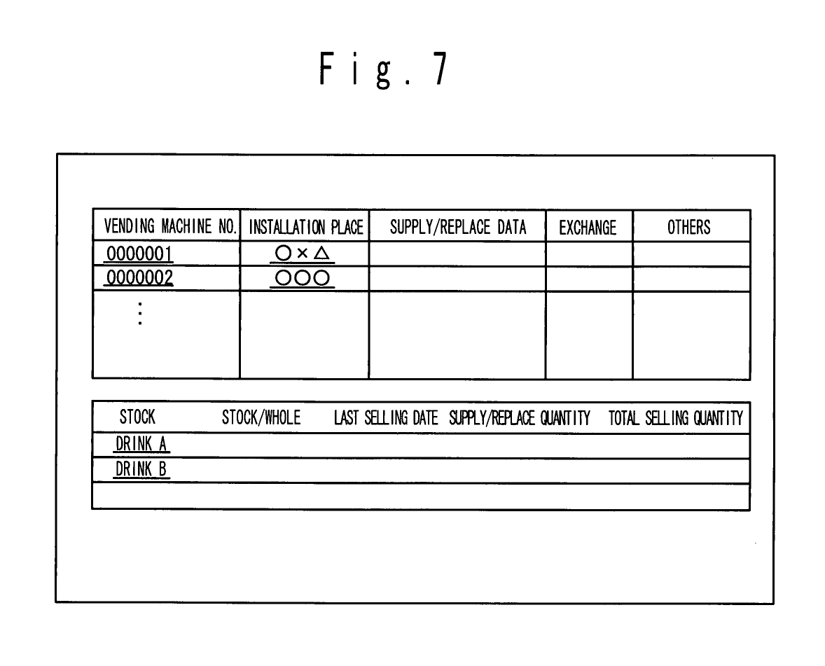

The maintenance terminal 40 retrieves the vending machines to which the sales engineer is in charge, and transmits a data transmission request to them other than the trouble data transmitting vending machine. Each of the vending machines to which the sales engineer is in charge transmits the operation state data to the maintenance terminal 40 in response to the data transmission request (step A13). When receiving the operation state data from the vending machines, the maintenance terminal 40 stores them in the table 41, and then merges the operation state data of all the vending machines to which the sales engineer is in charge to produce an area data (A10) and transmits the area data to the mobile terminal 30 (Step A11). The mobile terminal 30 receives and displays the area data, as shown in FIG. 7 (Step A12). Referring to FIG. 7, in the area data, a vending machine number, an installation place, a supply/replace data, a change, an article name for each slot, the number of stocks/whole, a last selling date, a supply/replace amount, and a total selling quantity are displayed. Thus, by using the area data, the sales engineer can maintain all the vending machine concerned with him while repairing the trouble data transmitting vending machine.

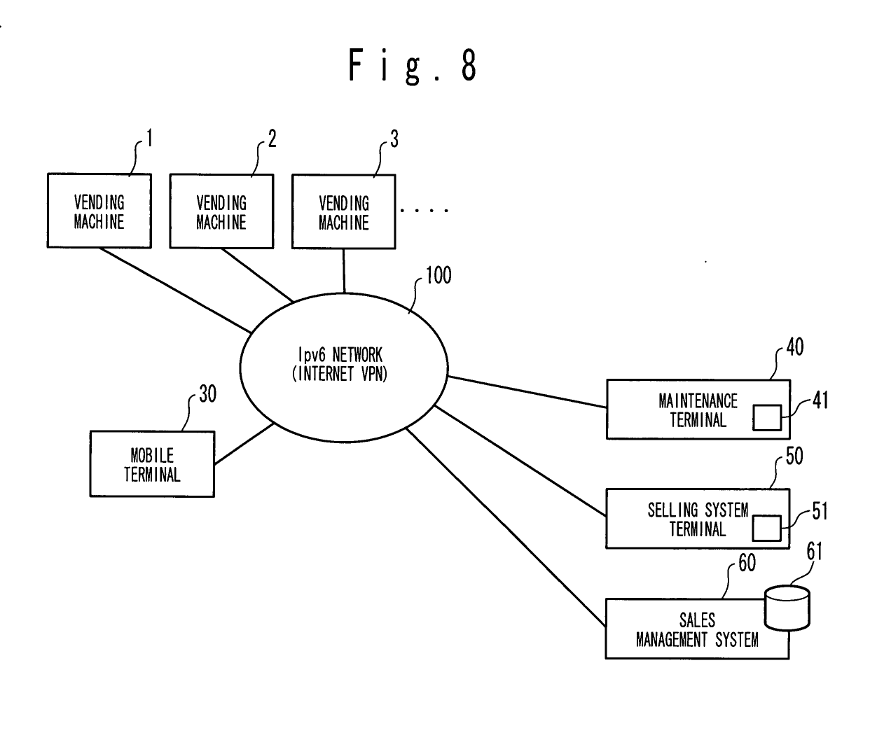

Next, the vending machine management system according to the second embodiment of the present invention will be described below in detail with reference to the drawing. Although the maintenance terminal 40, the selling system terminal 50 and the sales management system 60 are provided n the management center in the first embodiment, the maintenance terminal 40, the selling system terminal 50 and the sales management system 60 are independently connected with the network 100 in the second embodiment of the present invention, as shown in FIG. 8. The other configuration of the vending machine management system of the present invention is similar to the first embodiment. The maintenance terminal 40 periodically accesses the vending machines 1, 2, 3 and gathers the operation state data. The maintenance terminal 40 gathers, merges and holds the operation state data of all of the vending machines.

The selling system terminal 50 is installed separately from the maintenance terminal 40. The selling system terminal 50 periodically accesses the maintenance terminal 40 and gathers the operation state data of the vending machines. The gathered data is used as the selling data by the sales management system 60 for the sales analysis.

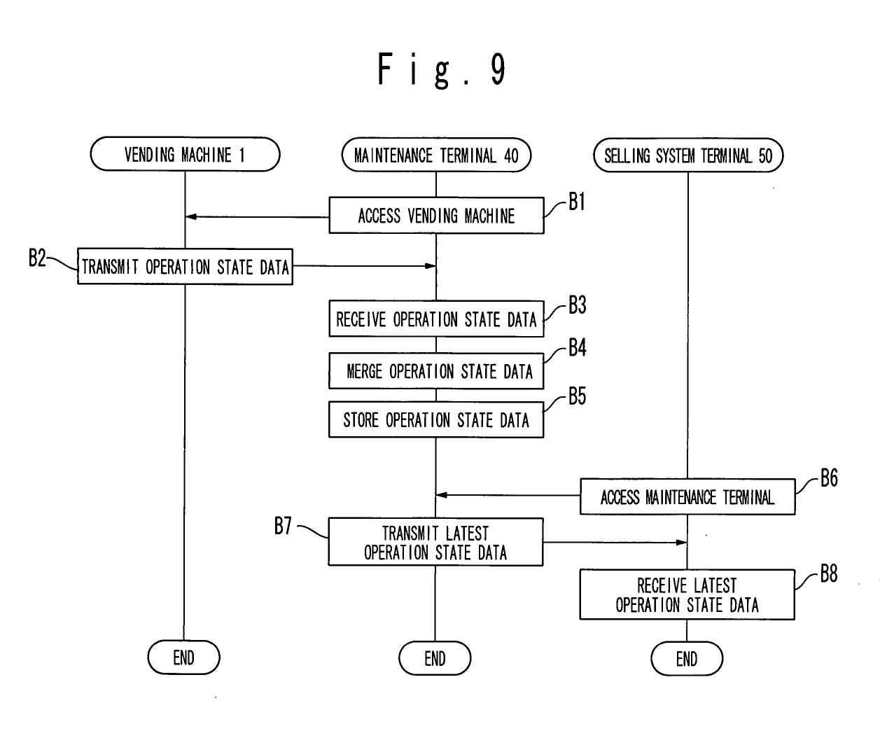

An operation of the second embodiment will be described below. Referring to FIG. 9, the maintenance terminal 40 periodically accesses all of the vending machines (FIG. 9 shows only the vending machine 1) to transmit a data transmission request to them through the Internet VPN 100 (Step B1). The vending machine 1 sends the operation state data indicative of the machine situation at this point to the maintenance terminal 40 through the Internet VPN 100 (Step B2). The maintenance terminal 40 receives the operation state data of the vending machine 1 through the Internet VPN 100 (Step B3) and similarly gathers the operation state data of all of the vending machines, and stores in the table 41. Then, the maintenance terminal 40 merges the gathered data (Step B4) and stores in the table 41 (Step B5)

Next, the selling system terminal 50 periodically accesses the maintenance terminal 40 through the Internet VPN 100 (Step B6). The maintenance terminal 40 transmits the newest vending machine operation state data to the selling system terminal 50 through the Internet VPN 100 (Step B7). The selling system terminal 50 receives the operation state data through the Internet VPN 100 (Step B8) and stores in the database 51. Then, the sales management system 60 uses the selling data of the operation state data and carrying out the sales analysis.

The above first and second embodiments may be combined. For example, the selling system terminal 51 is provided in the management center to retrieve the operation state data from the maintenance terminal for sales analysis.

According to the present invention, the management of the vending machine can be achieved by using the Internet and the like.

Also, the vending machine does not have a server function, and transmits various data generated by its self-machine. The various data are displayed on the maintenance terminal. Thus, it is possible to decrease the cost of the vending machine, and the vending machines can be collectively managed by the maintenance terminal. Also, it is enough to carry the minimum number of the articles at the time of the patrol to supplement the articles. Thus, the carrying cost can be dropped.

Also, when a trouble has occurred in the vending machine, the trouble data is promptly displayed on the maintenance terminal. Thus, the sales engineer can promptly grasp the trouble and cope with it by supplying the articles, supplying the changes and carrying out the repair and the like. Therefore, the loss of the selling chance can be reduced to a minimum.

Moreover, the various data generated by the vending machines are displayed on the mobile terminal. Thus, since the sales engineer has the mobile terminal, the sales engineer can promptly know the various data generated by the vending machine, even at the site where the sales engineer visits.

Moreover, a selling system terminal carries out a selling analysis on the basis of the various data with regard to the vending machines which are generated by the maintenance terminal. Thus, the maintenance terminal gathers the various data from all of the vending machines under the management. Therefore, it is possible to attain the selling analysis that is accurate and high in precision.

Moreover, since an IPv6 address is assigned to the vending machine, the vending machine can be identified at a low cost. Also, it is possible to cope with the increase in the number of the vending machines.

Moreover, the vending machine, the maintenance terminal, the mobile terminal and the selling system terminal are connected through VLAN on the Internet. Thus, the data communication can be attained which is low in cost and high in security.

1. A vending machine management system comprising:
a network;
a plurality of vending machines connected with said network, each of said plurality of vending machines transmitting a first data indicative of a trouble to a selling of articles stocked in the vending machine as a trouble occurring vending machine in case of occurrence of the trouble; and
a maintenance terminal receiving said first data from said trouble occurring vending machine, and displaying a second data indicative of a state of said trouble occurring vending machine based on said first data.

2. The vending machine management system according to claim 1, further comprising:
a mobile terminal receiving and displaying said second data which is transmitted from said maintenance terminal.

3. The vending machine management system according to claim 2, wherein said maintenance terminal transmits a data transmission request to said trouble occurring vending machine in response to the reception of said first data, and
said trouble occurring vending machine transmits said second data to said maintenance terminal.

4. The vending machine management system according to claim 2, wherein said mobile terminal is carried by a sales engineer and issues an area data request to said maintenance terminal,
said maintenance terminal searches said plurality of vending machine allocated to said sales engineer, and transmits said data transmission request to said plurality of searched vending machines other than said trouble occurring vending machine in response to said area data request, and
each of said plurality of searched vending machines other than said trouble occurring vending machine transmits said second data to said maintenance terminal,
said maintenance terminal produces an area data indicative of states of said plurality of searched vending machines from the received operation state data and transmits said area data to said mobile terminal, and
said mobile terminal displays said area data.

5. The vending machine management system according to claim 1, wherein said maintenance terminal transmits a state data request to said plurality of vending machines periodically,
each of said plurality of vending machines transmits said second data to said maintenance terminal in response to said state data request, and
said maintenance terminal holds said second data of each of said plurality of vending machines.

6. The vending machine management system according to claim 5, further comprising:
a sales management system; and
a selling system terminal collecting said second data of each of said plurality of vending machines and driving said sales management system to carry out a sales analysis based on the collected operation state data.

7. The vending machine management system according to claim 5, wherein an IPv6 address is allocated to each of said plurality of vending machines such that each of said plurality of vending machines is identified based on said IPv6 address on the Internet.

8. The vending machine management system according to claim 5, wherein each of said plurality of vending machines and said maintenance terminal communicate with each other on the Internet by using VLAN.

9. A method of managing vending machines, comprising:
transmitting a first data indicative of a trouble to a selling of articles stocked in a trouble occurring vending machine of said plurality of vending machines from said trouble occurring vending machine to said maintenance terminal;
collecting a second data indicative of a state of each of vending machines from each of said vending machines by a maintenance terminal;
transmitting said second data of said trouble occurring vending machine from said maintenance terminal to a mobile terminal; and
displaying said second data of said trouble occurring vending machine on said mobile terminal.

10. The method according to claim 9, wherein said collecting is carried out periodically.

11. The method according to claim 9, further comprising:
transmitting a second data request from said maintenance terminal to said trouble occurring vending machine; and
transmitting said second data from to said trouble occurring vending machine to said maintenance terminal in response to the second data request.

12. A software product executable by a computer, comprising the functions of:
accessing vending machines through a network to acquire a first data indicative of a state of each of said vending machines from said each vending machine; and
transmitting said first data of a trouble occurring vending machine of said vending machines to a mobile terminal carried by a sales engineer in response to a reception of a first data indicative of a trouble to a selling of stocked articles from said trouble occurring vending machine.

13. The software product according to claim 12, wherein said transmitting said second data comprises the functions of:
transmitting a data transmission request to said trouble occurring vending machine in response to the reception of said first data;
receiving said second data from said trouble occurring vending machine transmits; and
transmitting the received second data to said mobile terminal.

14. The software product according to claim 12, further comprising the functions of:
searching said vending machine allocated to said sales engineer in response to an area data request;
transmitting a data transmission request to said searched vending machines other than said trouble occurring vending machine;
receiving said second data of each of said searched vending machines other than said trouble occurring vending machine;
producing an area data indicative of states of said searched vending machines from the received second data; and
transmitting said area data to said mobile terminal, such that said mobile terminal displays said area data.

15. The software product according to claim 12, wherein said accessing comprises the function of:
accessing said vending machines periodically through a network to acquire said second data from each of said vending machines.

16. The software product according to claim 15, further comprising the functions of:
collecting said second data of each of said vending machines; and
carrying out a sales analysis based on the collected second data.
